(19) United States
(12) Patent Application Publication
(10) Pub. No.: US 2007/0242198 A1
(43) Pub. Date: Oct. 18, 2007

(54) Transflective LC Display Having Backlight With Temporal Color Separation

(75) Inventors: Philip E. Watson, St. Paul, MN (US); Andrew J. Ouderkirk, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/734,572

(22) Filed: Apr. 12, 2007

Related U.S. Application Data
(60) Provisional application No. 60/744,726, filed on Apr. 12, 2006.

(51) Int. Cl. G02F 1/1335

(52) U.S. Cl. 349/114

(57) ABSTRACT

A transflective display includes a liquid crystal (LC) panel having an array of pixels defining a viewing area, the panel being disposed between a front and back polarizer. The display also includes a backlight and a transflector, except that the transflector may optionally be or include the back polarizer. The transflector is disposed between the LC panel and the backlight. The backlight produces multiple light components that are separated temporally to give the display a full color appearance in the transmissive viewing mode. The multiple light components may be, for example, red, green, and blue light components, or another set of light components capable of producing white light in the eye of the observer when modulated rapidly.

### CROSS REFERENCE TO RELATED APPLICATIONS

This application claims the benefit under 35 U.S.C. §119(e) of U.S. Provisional Application No. 60/744,726, filed Apr. 12, 2006.

### FIELD OF THE INVENTION

The present invention relates to display devices, particularly those that utilize a liquid crystal (LC) panel and that can operate in both reflected ambient light and transmitted light originating from a backlight, and related articles and processes.

### DISCUSSION

Microprocessor-based devices that include electronic displays for conveying information to a viewer have become nearly ubiquitous. Mobile phones, handheld computers, personal digital assistants (PDAs), electronic games, MP3 players and other portable music players, car stereos and indicators, public displays, automated teller machines, in-store kiosks, home appliances, computer monitors, and televisions are examples of such devices. Many of the displays provided on such devices are liquid crystal displays (LCDs or LC displays).

Unlike cathode ray tube (CRT) displays, LCDs do not have a phosphorescent image screen that emits light and, thus, require a separate light source for viewing images formed on such displays. For example, a source of light can be located behind the display, which is generally known as a “backlight.” The backlight is situated on the opposite side of the LCD from the viewer, such that light generated by the backlight passes through the LCD to reach the viewer. An LC display using such a backlight can be said to be operating in “transmissive” mode. An alternative source of illumination can be from an external light source, such as ambient room lights or the sun.

Some LC displays are designed to operate in either of two modes: the transmissive mode utilizing a backlight, described above, or a “reflective” mode, utilizing light reflected from an external light source situated on the viewer-side of the LCD. Such LC displays, known as “transflective” displays, commonly possess an LC panel and a partially reflective layer between the LC panel and the backlight. In other cases, the partially reflective layer is disposed inside the LC panel rather than between the LC panel and the backlight. In either case, the partially reflective layer, referred to herein as a “transflector”, transmits a sufficient portion of light from the backlight, while also reflecting a sufficient portion of external light, to permit the display to be viewed in both transmissive mode and reflective mode. An exemplary transflector is Vikuiti™ Transflective Display Film (“TDF”) available from 3M Company. This film includes a reflective polarizer, i.e., a body that reflects light of one polarization state and transmits light of an orthogonal polarization state, formed from a polymeric multilayer optical film. The TDF product also includes a layer of diffuse adhesive.

The LC panel component of the LC display commonly includes two substrates and a liquid crystal material disposed between them. The substrates may be fabricated from glass, plastic, or other suitable transparent materials. The substrates are supplied with an array of electrodes that can provide electrical signals to a corresponding array of individual areas known as picture elements (pixels), which collectively define the viewing area of the display and individually define the resolution of the display. Electrical signals provided by the electrodes, typically in conjunction with thin film transistors (TFTs), permit the optics of each pixel to be adjusted, for example to either significantly modify the polarization state of transmitted light, or to allow the light to pass without significant modification to its polarization state. In some cases the electrical signal can switch the liquid crystal from a transmissive state to a scattering state, or provide some other optical change in the pixel. The LC panel typically does not include a highly absorptive color filter situated between the substrates. It may, however, include a weak color filter that absorbs less than 50% of incident light over the visible spectrum.

The liquid crystal material in the LC panel may be nematic, as in the case of a Twisted Nematic (TN), Optically Compensated Bend (OCB), Supertwisted Nematic (STN), or bistable nematic liquid crystal, or other known nematic modes. It may also be a smectic liquid crystal as used in Ferroelectric, Antiferroelectric, Ferrielectric, and other smectic modes. The liquid crystal may also be a cholesteric liquid crystal, a liquid crystal/polymer composite, a polymer-dispersed liquid crystal, or any other type of liquid crystal configuration that may be electrically switched between at least two optically differentiable states.

Usually, LC displays are either monochrome or color. In a monochrome display, each of the pixels in the viewing area can be made to be dark, bright, or an intermediate intensity level, as in a grayscale image. Such intensity modulation is usually used with white light (to yield pixels that are white, black, or gray) but can alternatively be used with light of any other single color such as green, orange, etc. But such intensity modulation cannot produce a range of colors at any arbitrary location on the viewing area. In contrast, “full color” LC displays can produce a range of perceived colors, such as red, green, or blue, at any arbitrary location within the viewing area.

One technique for obtaining full color performance from an LCD is to provide an absorbing (patterned) color filter between the transparent substrates of the LC panel. In such a case, each pixel is subdivided into three or more regions or subpixels, each of which is individually controllable and associated with a particular color of the absorbing color filter, such as the primary colors of red, green, and blue, or other color combinations capable of producing substantially white light. If such a color filter is used in the LC panel of a transflective display, the high average absorption of the color filter substantially reduces the achievable brightness of both the transmissive and reflective operating modes, limiting the display's ability to present easily viewable images.

The design of traditional transflective systems often involves compromises between reflective brightness, transmissive brightness, and color generation. Typically, a transflective layer, located either between the transparent substrates of the liquid crystal panel, or between the liquid crystal panel and the backlight, will reflect a fraction of incident light in order to provide illumination from external sources in the reflective mode, and will transmit a different fraction of incident light in order to provide illumination from the backlight in the transmissive mode. The design of the transflector may be tuned such that the transmissive mode or reflective mode is brighter, often at the expense of the other.

### BRIEF SUMMARY

The present application discloses, inter alia, a transflective display having a reflective viewing mode and a transmissive viewing mode. The display includes a liquid crystal (LC) panel having an array of pixels defining a viewing area, the panel being disposed between a front and back polarizer. The display also includes a backlight and a transflector, except that the transflector may optionally be or include the back polarizer. The transflector is disposed between the LC panel and the backlight. The backlight produces multiple light components that are separated temporally to give the display a full color appearance in the transmissive viewing mode. The multiple light components may be, for example, red, green, and blue light components, or another set of light components capable of producing white light.

In exemplary embodiments, the backlight includes multiple LED light sources, and each LED light source emits one of the multiple light components. Preferably, as the backlight emits each light component, the light component illuminates substantially every pixel in the pixel array.

At least some of the disclosed LC displays are capable of monochrome operation in reflective mode and full color operation in transmissive mode. This is because the differently colored light components responsible for the full color operation are produced by the backlight rather than by a color filter residing in the LC panel or at another position in the light path of the reflective mode. The same pixels can be used for both modes for enhanced efficiency, also enabling the same higher resolution operation in the reflective mode as in the transmissive mode.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic side view of a portion of a transflective liquid crystal display having a backlight with temporal color separation;

FIG. 2 is a composite graph of intensity versus time for the various light components emitted by the backlight; and

FIG. 3 is a schematic side view of a portion of another transflective liquid crystal display having a backlight with temporal color separation.

In the figures, like reference numerals designate like elements.

### DETAILED DESCRIPTION OF ILLUSTRATIVE EMBODIMENTS

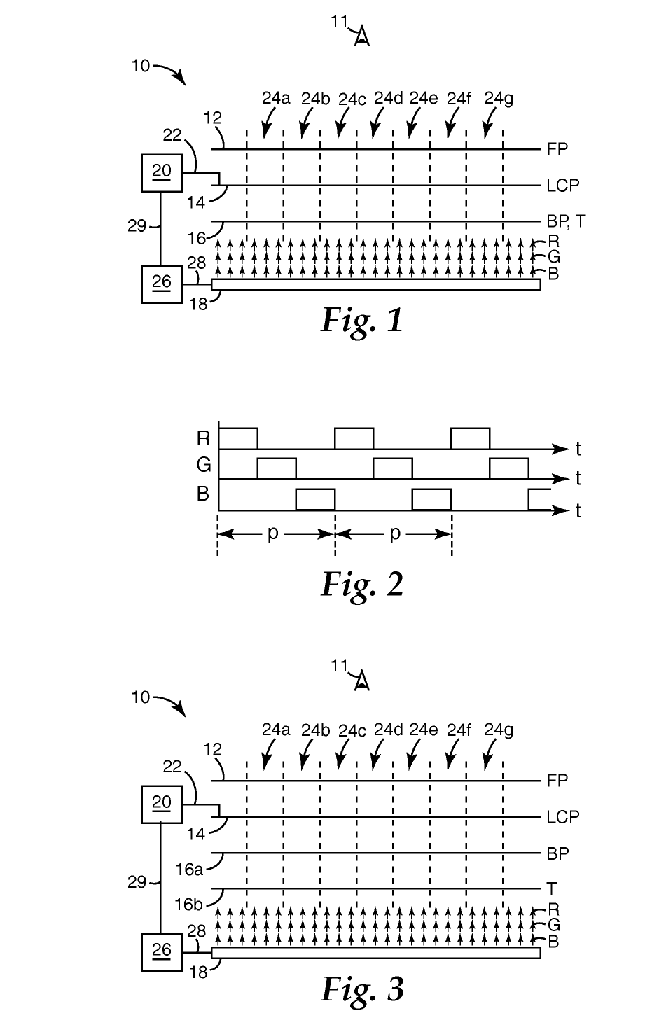

FIG. 1 shows a schematic side view of a portion of a transflective LC display 10 that includes a front polarizer 12, an LC panel 14, a back polarizer 16, and a backlight 18. A controller 20 is electronically coupled to LC panel 14 via a connection 22 to control the optical state of individual pixels 24a-g of the LC panel, which pixels extend in a repeating pattern or array over an area that defines the overall viewing area of the display. Another controller 26 is electronically coupled to backlight 18 via a connection 28 to control the operation thereof as explained further below. Another connection 29 between controllers 20, 26 allows for synchronized operation of the LC panel and the backlight.

Front polarizer 12 can be any known polarizer, but in exemplary embodiments it is an absorptive polarizer (sometimes also referred to as a dichroic polarizer) for ease of viewing and reduced glare for observer 11. Preferably, polarizer 12 is a flexible polymer-based film and is laminated or otherwise adhered to LC panel 14, for example, using an optically clear adhesive. If polarizer 12 is a linear polarizer, it has a pass axis and a block axis in the plane of the film or layer. Light polarized parallel to the pass axis is transmitted, and light polarized parallel to the block axis (perpendicular to the pass axis) is blocked e.g. by absorption, by the front polarizer 12.

LC panel 14 includes a liquid crystal material sealed between two transparent substrates and an array of electrodes that define a corresponding array of pixels 24a-g. A controller 20 is capable of addressing or controlling each of the pixels individually so as to form a desired image. Depending on whether a given pixel is turned on or off, or at an intermediate state, the LC panel rotates the polarization of light passing therethrough by about 90 degrees, or by about zero degrees, or by an intermediate amount. The LC panel may have its front face attached to the front polarizer, and may also include a diffuser film, an antireflection film, an anti-glare surface, or other front-surface treatments.

Back polarizer 16 is a reflective polarizer, preferably but not necessarily of polymeric multilayer design as described in U.S. Pat. No. 5,882,774 (Jonza et al.), or U.S. Application Publication Nos. 2002/0190406 (Merrill et al.), 2002/0180107 (Jackson et al.), 2004/0099992 (Merrill et al.) and 2004/0099993 (Jackson et al.). As such, the polarizer 16 has a pass axis and a block axis in the plane of the polarizer, where light polarized parallel to the pass axis is substantially transmitted and light polarized parallel to the block axis is substantially reflected by the polarizer 16. Absorption in the polarizer 16 is typically negligible, particularly over visible wavelengths. The pass axis of the back polarizer 16 can have any desired orientation with respect to the pass axis of front polarizer 12, but for purposes of the present description we will assume it is perpendicular thereto. In such case, display 10 is an inverting-type transflector, because pixels 24 whose state (determined by controller 20) makes them bright in reflective viewing mode makes them dark in transmissive viewing mode, and pixels 24 whose state makes them dark in reflective viewing mode makes them bright in transmissive viewing mode. (Discussed below in connection with FIG. 3 is a non-inverting display, where pixels whose state makes them bright in reflective viewing mode makes them bright in transmissive viewing mode, and pixels whose state makes them dark in reflective viewing mode also makes them dark in transmissive viewing mode.)

In this regard, transflective displays generally fall under two classes of operation: inverting and non-inverting. Non-inverting displays provide the same image in both the reflective and transmissive operating modes, because in both cases, any light that exits the display travels from the transflector to the back polarizer (which defines the light's polarization state), through the LC panel, and exits through the front polarizer. External light incident on the display passes through the front polarizer, through the LC panel, through the back polarizer, reflects from the transflector, passes back through the back polarizer and the LC panel, and exits through the front polarizer. Light from the backlight passes through the transflector, through the back polarizer, through the LC panel, and exits through the front polarizer. Since the two operating modes provide similar images (although the reflective-mode image will be monochrome while the backlit image may be colored), then the light exiting the system from the reflective and transmissive modes will work together to provide a brighter overall image. Typically, in cases where the transflector does not also act as the display back polarizer, the display is non-inverting. But some non-inverting displays can include a reflective polarizer as the transflector.

Inverting displays commonly utilize a reflective polarizer for the transflector, and that reflective polarizer is also the back polarizer of the LC display. The transflector may, for example, be a sheet of Vikuiti™ RDF-C film (3M Company, St. Paul, Minn.) laminated in place of a conventional absorptive back polarizer in the display. The RDF-C film includes a polymeric multilayer reflective polarizer and a layer of light-diffusing adhesive. In this case, external light incident on the display passes through the front polarizer, then through the LC panel, and impinges on the transflector. At this point, one polarization state (state “1”) is reflected, and passes back through the LC panel and the front polarizer. But light of an orthogonal polarization state (state “2”) is transmitted by the transflector and is absorbed or otherwise lost in the vicinity of the backlight. For light originating from the backlight, polarization state 2 is transmitted through the transflector, through the LC panel, and through the front polarizer, while polarization state 1 is reflected back into the backlight and lost. Thus, the reflective operating mode introduces polarization state 1 into the LC panel, while the transmissive operating mode introduces polarization state 2 into the LC panel, and the two images will therefore be reversed. Consequently, the transmissive mode image appears as a photo-negative of the reflective mode image, except that the transmissive mode image may contain bright colors, while the reflective mode image may be monochrome.

In the case of inverting displays, it is also possible to modify the image output electronically using controller 20 in order to correct for the optical inversion. Controller 20 may for example include an electronic inversion algorithm that is activated or not depending upon whether the backlight 18 is energized, i.e., depending on whether the display 10 is in reflective mode or transmissive mode. Such an algorithm can electronically modify the control signals to the individual pixels to electronically invert the image in the transmissive mode when the backlight is activated, so that the image appears with the same foreground/background scheme as in the reflective mode.

In LC display 10, the back polarizer 16 also serves as the transflector. If desired, a polarization-preserving light diffusing layer can also be included as part of the transflector to enhance the appearance of the image. The transflector 16 is situated between the LC panel 14 and the backlight 18 such that it can reflect light from external sources such as room lights or the sun.

The transflector may include any multilayer optical film having a polarizing function, including the line of Vikuiti™ DBEF products, Vikuiti™ TDF film, Vikuiti™ RDF-C film, and the polarizers described in the '774 Jonza et al. patent above. The transflector may also include a second reflective polarizer aligned with its pass axis rotated with respect to the pass axis of the first reflective polarizer. In a related configuration, the transflector may also be or include a reflective cholesteric liquid crystal polymer layer that transmits one circular polarization state of light and reflects another. Such a transflector may also include a wave plate, such as a ¼ wave retarder, to modify the polarization state of light from circular to linear and vice versa. The transflector may also have a reflection and/or transmission spectrum that varies over the visible spectrum.

The transflector can be affixed to the LC display (or to a separate back polarizer, if one exists distinct from the transflector) using a diffusing adhesive, a clear adhesive, or other means, or may be free-floating, or affixed to the backlight 18. It may include additional layers and coatings such as laminated plastic or glass films that provide durability, rigidity, environmental robustness, or EMI shielding, or that may provide other optical effects such as diffusion, anti-reflection, or anti-glare properties.

Backlight 18 produces multiple light components that are separated temporally to give the display a full color appearance in the transmissive viewing mode. In other words, backlight 18 emits a timed sequence of different colored light beams, each such beam preferably illuminating all pixels within the viewing area of the display, but emitted in such rapid succession that the observer 11 perceives only a time-average the emitted beams. This is depicted pictorially in FIG. 1 by the beams labeled R, G, B emitted by backlight 18 in a sequence. Although the R, G, B labels may refer to red, green, and blue, other additive color schemes are also contemplated, including schemes having two, three, four, or more colors. The intensities, wavelength ranges (colors), and cycle times of the respective emitted light components can all be selected or adjusted to produce any desired viewing characteristic, but normally the variables are adjusted so that the time-average of the emitted beams is perceived as substantially white light to a standard observer. Note that no great care is required to align backlight 18 to the pixel array of the LC panel 14. This is because, preferably, each light component illuminates substantially the entire viewing area of the display. Furthermore, there is usually no requirement to collimate the emitted light to any substantial degree. In some cases, however, the backlight 18 may include a collimating film or device in order to reduce color mixing between adjacent pixels, or when the LC display includes multilayer optical films or other interference reflectors having reflection and transmission properties that can shift as a function of incidence angle.

Backlight 18 includes a plurality of light sources that can be separately modulated in intensity and that emit in distinct wavelength bands. Such an approach is referred to generally as a Field Sequential Color (FSC) technique. LED sources, which are available in a range of output wavelengths covering the entire visible and near IR spectrum, and which are solid state in design, bright, robust, reliable, and easily modulated at high speeds, are exemplary light sources for this purpose. Alternatively, fluorescent sources such as Cold Cathode Fluorescent Lamps (CCFLs) that are adapted to emit light in a specific wavelength range of the visible spectrum may be used. At least two different light sources emitting in at least two distinct spectral ranges are provided, with the light output from these sources cycled at a frequency of at least 40 Hz or faster for a full cycle, so that the appearance of the backlight is approximately white to the human eye. This is most commonly achieved using at least two, and preferably three or more, different colored light sources, such as LEDs with specific wavelength ranges, or CCFL bulbs that emit light with specific wavelength ranges.

Although shown only schematically, backlight 18 also typically includes conventional components such as light guides, light enhancement films, lenses, and other components to provide preferably substantially uniform and efficient illumination over the viewing area of the display.

Typically, backlight 18 includes three different types of LED sources, one type emitting substantially blue light, another type emitting substantially green light, and still another type emitting substantially red light. Such a situation is depicted in FIG. 2, which shows a composite graph of the intensities of three types of light sources R/G/B in backlight 18 as a function of time t. Controller 26 alternately energizes the light sources in a repeating sequence. One full cycle of the sequence has a period p. Preferably, p corresponds to a frequency of 40 Hz, 75 Hz, or more.

In the transmissive viewing mode of display 10, controller 26 is synchronized with the LC panel controller 20 via connection 29, so that the appropriate set of pixels 24 is addressed for the appropriate color being emitted by the backlight. This synchronization is helpful to ensure an accurate representation of the desired full color image.

If desired, controller 26 can also operate in a mode that does not achieve full color over the full viewing area. Such a mode, referred to herein as “white mode”, provides a monochrome image and may be useful for example to illuminate an image containing substantially only two-color (e.g. black and white) information, such as standard text in a word processor. In white mode, controller 26 activates all light sources simultaneously, whether continuously or in a modulated fashion, allowing a brighter backlight than with the modulated R/G/B full color mode. Alternatively, in a modified version of white mode in cases where power conservation is important, less than all of the light sources or even only one type of light source can be activated simultaneously, again providing a monochrome image but in a dimmer display, and with light of a background color different than white. The one type of light source may be, for example, all of the red light sources, or all of the green light sources, or all of the blue light sources.

FIG. 3 shows a portion of an LC display 40 similar to display 10 of FIG. 1, but where the combined back polarizer/transflector 16 is replaced by a separate back polarizer 16a and transflector 16b. Back polarizer 16a may be an absorptive polarizer, or any other polarizer having insufficient reflectivity to support the reflective viewing mode of the display. Transflector 16b can be or comprise a non-polarizing partially reflective layer, such as a light diffusing layer, or it can be or comprise a reflective polarizer whose pass axis is not aligned with the pass axis of back polarizer 16a, or it can comprise both such features. Exemplary embodiments of transflector 16b include the same components useable with transflector 16 of FIG. 1, including Vikuiti™ RDF-C film, Vikuiti™ TDF film, Vikuiti™ DBEF series of reflective polarizers, cholesteric-based reflective polarizers, and wire grid polarizers including those available from Moxtek Inc.

Because LC display 40 includes an absorptive back polarizer 16a in front of the transflector, it is a non-inverting display. Pixels that are bright in reflective viewing mode are also bright in transmissive viewing mode, and pixels that are dark in reflective viewing mode are also dark in transmissive viewing mode. Therefore, controller 20 need not include software to electronically invert the pixels of the LC panel 14, and the ambient light and backlit lighting are additive in increasing display brightness.

Unless otherwise indicated, all numbers expressing quantities, measurement of properties and so forth used in the specification and claims are to be understood as being modified in all instances by the term “about.” Accordingly, unless indicated to the contrary, the numerical parameters set forth in the specification and claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The foregoing description is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention. All patents and patent applications referred to herein are incorporated by reference in their entireties, except to the extent they are contradictory to the foregoing specification.

1. A transflective display having a reflective viewing mode and a transmissive viewing mode, the display comprising:
a liquid crystal (LC) panel having an array of pixels;
a front and back polarizer disposed on opposed sides of the LC panel;
a backlight;
a transflector, which may optionally be or include the back polarizer, disposed between the LC panel and the backlight;
wherein the backlight produces multiple light components that are separated temporally to give the display a full color appearance in the transmissive viewing mode.

2. The display of claim 1, wherein the transflector includes the back polarizer, and the back polarizer is a reflective polarizer.

3. The display of claim 1, wherein the front and back polarizers are absorptive polarizers, and wherein the transflector includes a reflective polarizer and a light diffusing layer.

4. The display of claim 1, wherein the multiple light components are substantially red, green, and blue.

5. The display of claim 1, wherein each one of the multiple light components illuminates substantially all of the pixels in the array.

6. The display of claim 1, wherein the backlight comprises multiple LED light sources that emit the multiple light components respectively.

7. The display of claim 1, wherein the backlight includes a plurality of light sources that can be separately modulated in intensity and that emit in distinct wavelength bands, the display further comprising:
a controller electronically coupled to the backlight, the controller having a first mode of operation wherein the light sources are energized in a sequence that produces the temporally separated multiple light components.

8. The display of claim 7, wherein the controller also has a second mode of operation, in which substantially all of the light sources can be activated simultaneously, whether continuously or in a modulated fashion.

9. The display of claim 7, wherein the controller also has a third mode of operation, in which less than all of the light sources are activated simultaneously in order to provide a monochrome image.

10. The display of claim 9, wherein the third mode of operation provides the monochrome image by activating only one type of the plurality of light sources.

11. The display of claim 10, wherein the one type of the plurality of light sources refers to light sources that emit a particular color.
